(19) United States
(12) Patent Application Publication
(10) Pub. No.: US 2018/0165685 A1
(43) Pub. Date: Jun. 14, 2018

(54) Method, Terminal, and Related Server for Providing Transaction Object

(71) Applicant: Alibaba Group Holding Limited, Grand Cayman (KY)

(72) Inventor: Liyan Sun, Hangzhou (CN)

(21) Appl. No.: 15/893,384

(22) Filed: Feb. 9, 2018

Related U.S. Application Data
(63) Continuation of application No. PCT/CN2016/092674, filed on Aug. 1, 2016.

(30) Foreign Application Priority Data
Aug. 10, 2015 (CN) 201510487954.4

(51) Int. Cl. G06Q 20/40; G06Q 20/12

(52) U.S. Cl. CPC G06Q 20/4037; G06Q 20/12

(57) ABSTRACT

A terminal receives a pushed transaction object detail page that includes resource deduction information. The terminal receives, on the transaction object detail page, a resource deduction mode selected by a user according to the resource deduction information, generates a resource deduction request according to the selected resource deduction mode and sends the resource deduction request, so that a network server carries out resource deduction according to the resource deduction request. A second server abates a deduction resource after a first server provides a transaction object for the terminal, uses the abated deduction resource as first payment information of the transaction object to pay for the transaction object, and carries out deduction processing on the remaining deduction resource after the abatement according to the resource deduction mode. The operation efficiency of the user is improved. The present disclosure relates to the field of communications technologies.

### CROSS REFERENCE TO RELATED PATENT APPLICATIONS

This application claims priority to and is a continuation of PCT Patent Application No. PCT/CN2016/092674, filed on 1 Aug. 2016, which claims priority to Chinese Patent Application No. 201510487954.4, filed on 10 Aug. 2015 and entitled “Method, Terminal, and Related Server for Providing Transaction Object,” which are incorporated herein by reference in their entirety.

### TECHNICAL FIELD

The present disclosure relates to the field of communications technologies, and, more particularly, to methods, terminals, and related servers for providing transaction object.

### BACKGROUND

With the rapid development of Internet technologies and the logistics industry, e-commerce devices provide increasingly richer services for users, so that the users may shop without leaving their homes. However, a user needs to make an online payment through a payment account each time using a service provided by an e-commerce device. The user is not allowed to use the service provided by the e-commerce device when the balance of the payment account is insufficient to complete the payment. Therefore, the user needs to confirm before each payment whether the balance of the payment account is sufficient for the current payment. Users who make payments frequently need to confirm the balance of their payment accounts frequently, and need to recharge immediately when the balance is insufficient. Such repeated balance confirmation and recharging operations not only lower the operation efficiency of the users, but also lower the quality of service of a system.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure.

With the increase of types of financial products on the market, people's financial awareness grows gradually. The method of directly deducting account principal in the conventional payment mode requires a user to confirm before each payment whether the balance of a payment account is sufficient to complete the current payment, which lowers the operation efficiency of the user and lowers the quality of service of a system. Moreover, such a method conflicts with the modern financial concepts. Increasingly more and more people look forward to a new payment mode to replace the conventional payment mode, so that they may obtain favorite transaction objects without using the principal of their payment accounts during online shopping. Therefore, there is an urgent need for an improved payment mode that may not only improve the operation efficiency of the users as well as the quality of service of the system, but also meet the modern financial concepts.

In the context, implementations of the present disclosure are intended to provide a transaction object providing method, terminal, and related server, in which a resource deduction mode is used as a new payment mode in the process of providing a transaction object to a user, so as to solve the problems in the prior art that the operation efficiency is low when a user acquires a service provided by an e-commerce device and the conventional payment mode cannot meet people's requirements.

Based on the foregoing problems, an example embodiment of the present disclosure provides a first transaction object providing method, including:

receiving a transaction object detail page pushed by a network server, wherein the transaction object detail page includes resource deduction information, and a resource deduction mode represented by the resource deduction information is used for replacing a payment mode of directly paying for a transaction object corresponding to the transaction object detail page;

receiving, on the transaction object detail page, a resource deduction mode selected by a user according to the resource deduction information; and

generating a resource deduction request according to the selected resource deduction mode and sending the resource deduction request, so that the network server carries out resource deduction according to the resource deduction request.

An example embodiment of the present disclosure provides a second transaction object providing method, including:

pushing a transaction object detail page to a terminal, wherein the transaction object detail page includes resource deduction information, and a resource deduction mode represented by the resource deduction information is used for replacing a payment mode of directly paying for a transaction object corresponding to the transaction object detail page;

receiving a transaction object acquisition request sent by the terminal; and

receiving first payment information of the transaction object from a second server after the transaction object is provided for the terminal.

An example embodiment of the present disclosure provides a third transaction object providing method, including:

sending resource deduction information, wherein the resource deduction information is displayed on a transaction object detail page, and a resource deduction mode represented by the resource deduction information is used for replacing a payment mode of directly paying for a transaction object corresponding to the transaction object detail page;

receiving a resource deduction request, wherein the resource deduction request is generated by a terminal based on a resource deduction mode that a user selects according to the resource deduction information;

abating a deduction resource, and using the abated deduction resource as first payment information of the transaction object to pay for the transaction object; and

carrying out deduction processing on the remaining deduction resource after the abatement according to the resource deduction mode.

An example embodiment of the present disclosure provides a terminal, including:

a receiving module configured to receive a transaction object detail page pushed by a network server, wherein the transaction object detail page includes resource deduction information, and a resource deduction mode represented by the resource deduction information is used for replacing a payment mode of directly paying for a transaction object corresponding to the transaction object detail page; and receive, on the transaction object detail page, a resource deduction mode selected by a user according to the resource deduction information; and

a sending module configured to generate a resource deduction request according to the selected resource deduction mode and send the resource deduction request, so that the network server carries out resource deduction according to the resource deduction request.

An example embodiment of the present disclosure provides a server, as a first server, including:

a pushing module configured to push a transaction object detail page to a terminal, wherein the transaction object detail page includes resource deduction information, and a resource deduction mode represented by the resource deduction information is used for replacing a payment mode of directly paying for a transaction object corresponding to the transaction object detail page; and

a receiving module configured to receive a transaction object acquisition request sent by the terminal; and receive first payment information of the transaction object from a second server after the transaction object is provided for the terminal.

An example embodiment of the present disclosure provides a server, as a second server, including:

a sending module configured to send resource deduction information, wherein the resource deduction information is displayed on a transaction object detail page, and a resource deduction mode represented by the resource deduction information is used for replacing a payment mode of directly paying for a transaction object corresponding to the transaction object detail page;

a receiving module configured to receive a resource deduction request, wherein the resource deduction request is generated by a terminal based on a resource deduction mode that a user selects according to the resource deduction information; and

a deduction resource processing module configured to abate a deduction resource, and use the abated deduction resource as first payment information of the transaction object to pay for the transaction object; and carry out deduction processing on the remaining deduction resource after the abatement according to the resource deduction mode.

The example embodiments of the present disclosure provide a transaction object providing method, terminal, and related server. The terminal receives a pushed transaction object detail page that includes resource deduction information. The terminal receives, on the transaction object detail page, a resource deduction mode selected by a user according to the resource deduction information, generates a resource deduction request according to the selected resource deduction mode and sends the resource deduction request, so that a network server carries out resource deduction according to the resource deduction request. A second server abates a deduction resource after a first server provides a transaction object for the terminal, uses the abated deduction resource as first payment information of the transaction object to pay for the transaction object, and carries out deduction processing on the remaining deduction resource after the abatement according to the resource deduction mode. The transaction object providing method in the example embodiments of the present disclosure provides a user with a mode of deducting from a deduction resource to replace the conventional payment mode of directly paying for a transaction object. When a user needs to acquire a transaction object, a server feeds back to a terminal a resource deduction mode capable of producing a value at least equivalent to the transaction object. Deduction is carried out on a deduction resource according to the resource deduction mode, so that the user may acquire the transaction object without making a payment. When needing to acquire multiple transaction objects successively, the user does not need to make multiple payments or confirm whether the balance of a payment account is sufficient before each payment. The user may acquire the transaction objects by allowing the server to carry out deduction on the deduction resource according to the determined resource deduction mode. The method not only improves the operation efficiency of the user as well as the quality of service of the server, but also meets the modern financial concepts of the user.

### BRIEF DESCRIPTION OF THE DRAWINGS

To illustrate the technical solutions in the example embodiments of the present disclosure clearly, the accompanying drawings for describing the example embodiments will be introduced briefly. Apparently, the accompanying drawings in the following description only represent some example embodiments of the present disclosure. Those of ordinary skill in the art may further obtain other drawings according to these accompanying drawings without creative efforts.

FIG. 1 is a flowchart of a transaction object providing method applied to a terminal according to a first example embodiment of the present disclosure;

FIG. 2 is a flowchart of a transaction object providing method applied to a first server according to a second example embodiment of the present disclosure;

FIG. 3 is a flowchart of a transaction object providing method applied to a second server according to a third example embodiment of the present disclosure;

FIG. 4 is a schematic structural diagram of a terminal according to an example embodiment of the present disclosure;

FIG. 5 is a schematic structural diagram of a first server according to an example embodiment of the present disclosure; and

FIG. 6 is a schematic structural diagram of a second server according to an example embodiment of the present disclosure.

### DETAILED DESCRIPTION

The example embodiments of the present disclosure provide a transaction object providing method, terminal, and related server. Preferred example embodiments of the present disclosure are described below with reference to the accompanying drawings. It should be understood that the preferred example embodiments described here are only used for illustrating and explaining the present disclosure, but are not intended to limit the present disclosure. The example embodiments of the present application and features in the example embodiments may be combined without contradiction.

The method and related device provided in the present disclosure are described in detail below with reference to the accompanying drawings and specific example embodiments.

In the example embodiments of the present disclosure, a server that provides a transaction object for a terminal may be the same as or different from a server that provides resource deduction information for the terminal and carries out deduction processing on a deduction resource provided by the terminal. When the servers are different, a first server may be used as a transaction server for providing a transaction object, and a second server may be used as a payment server for providing resource deduction information for a terminal and carrying out deduction processing on a deduction resource provided by the terminal.

A first example embodiment:

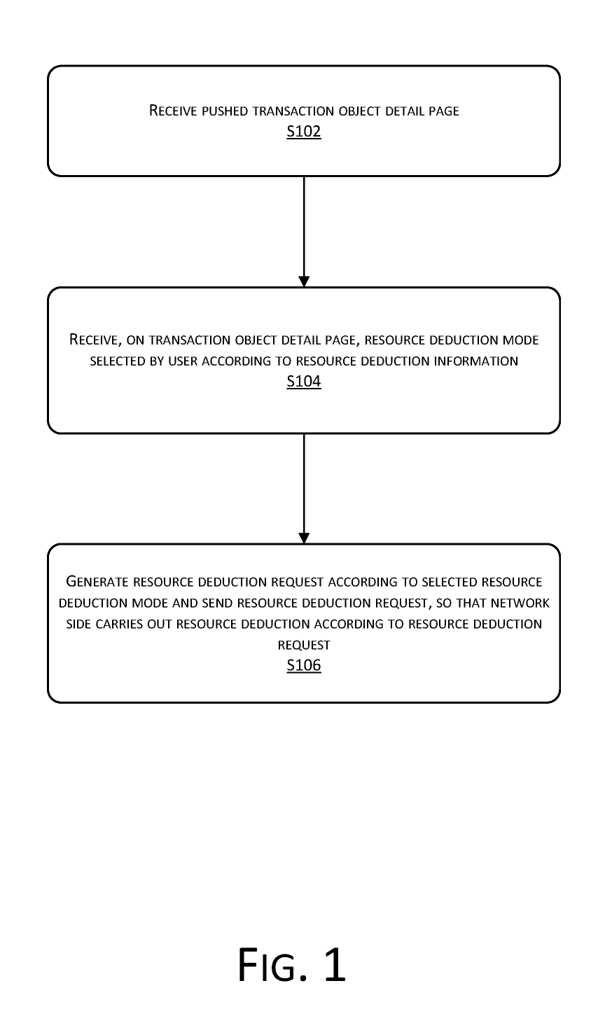

The first example embodiment of the present disclosure provides a transaction object providing method applied to a terminal. As shown in FIG. 1, the method includes the following steps:

S102: A transaction object detail page pushed by a network server is received, wherein the transaction object detail page includes resource deduction information, and a resource deduction mode represented by the resource deduction information is used for replacing a payment mode of directly paying for a transaction object corresponding to the transaction object detail page.

In this step, the terminal may select a needed transaction object according to its own requirement, and request the transaction object from a related server (such as a first server). In a specific implementation, the related server may display provided transaction objects on a webpage, and push, to the terminal, a transaction object detail page corresponding to a transaction object selected by the terminal. That is, the terminal may request the transaction object from the related server by using an http request message. The related server may push the transaction object detail page to the terminal by using an http response message.

The transaction object provided on the transaction object detail page may be paid for in one or more modes. It is possible to make a payment directly through a payment platform (i.e., the conventional payment mode), or make a payment by means of resource deduction. The payment mode based on resource deduction is a new payment mode provided in the example embodiment of the present disclosure to replace the conventional payment mode. In the new payment mode, a specified resource is pledged to produce a value at least equivalent to the transaction object corresponding to the transaction object detail page, and the generated value is used to pay for the transaction object. As such, the user obtains the needed transaction object by completing the payment without reducing the principal of a payment account of the user, which meets the modern financial demand of the user.

The transaction object detail page includes resource deduction information. The resource deduction information may be used for representing a resource deduction mode that replaces the conventional payment mode. The resource deduction information may be provided for the user in various forms. For example, the resource deduction information may include a deduction resource (such as money or goods) for deduction, and a deduction amount measuring parameter value corresponding to the resource (the parameter value is a deduction amount, a deduction period or the like for money, and is a deduction quantity, a deduction period or the like for goods).

Different information on the transaction object detail page may be provided by a same server or different servers on the network server. If the information is provided by a same server, the server provides both services and payment, and such a case is not described in detail in the example embodiment of the present disclosure. If the information is provided by different servers, for example, transaction object-related information on the transaction object detail page may be provided by a first server (transaction server), and the resource deduction information on the transaction object detail page may be provided by a second server (payment server), the second server further needs price information of the transaction object when determining the resource deduction information. The price information may be sent to the second server in different manners when the terminal receives the transaction object detail page (in the process of opening and displaying the transaction object detail page). The price information may be sent mainly in the following two manners:

In the first manner, the first server sends the price information of the transaction object to the second server:

When the terminal receives the transaction object detail page, the first server sends the price information of the transaction object to the second server, so that the second server determines the resource deduction information according to the price information and a current real-time dynamic income, and feeds back the determined resource deduction information to the first server; and the first server sends the resource deduction information to the transaction object detail page for displaying.

In the second manner, the terminal sends the price information of the transaction object to the second server:

A payment information invoking module may be set on the transaction object detail page. After the transaction object detail page pushed by the network server is received, the payment information invoking module is triggered to send the price information of the transaction object to the second server, so that the second server determines the resource deduction information according to the price information and a current real-time dynamic income, and feeds back the determined resource deduction information to the transaction object detail page for displaying.

S104: A resource deduction mode selected by a user according to the resource deduction information is received on the transaction object detail page.

Different resource deduction modes may consist of pairs of parameter values corresponding to different deduction items. Specifically, the deduction item may include a deduction amount and a deduction period. The parameter value corresponding to the deduction amount is a limit, and the parameter value corresponding to the deduction period is a duration. Different limits may correspond to different durations, and parameter pairs consisting of different limits and durations may correspond to different resource deduction modes.

Different users have different requirements when using principal on payment accounts to carry out resource deduction. In other words, some users want the deduction period to be as short as possible, and some users want the deduction amount to be as small as possible. In order to meet different requirements of different users, parameter pairs corresponding to multiple different deduction items may be used to represent different resource deduction modes. A user who wants the deduction period to be as short as possible may select a resource deduction mode with a relatively high limit and a short duration to make a payment. A user who wants the deduction amount to be as small as possible may select a resource deduction mode with a relatively low limit and a long duration to make a payment.

The resource deduction information may be presented on the transaction object detail page in many forms. The following two forms are used as examples for description:

First form: the resource deduction information includes a first deduction item and different first parameter values of the first deduction item. The first parameter value is a limit when the first deduction item is a deduction amount, and the first parameter value is a duration when the first deduction item is a deduction period.

In the first form of the resource deduction information, the resource deduction information may include different first parameter values corresponding to a deduction item (the first deduction item). The first parameter value is a limit when the first deduction item is a deduction amount, and the first parameter value is a duration when the first deduction item is a deduction period.

Assuming that the price of the transaction object on the transaction object detail page is 99 yuan, multiple limits (first parameter values) of the deduction amount may be displayed on the transaction object detail page for the user to choose from if the first deduction item is the deduction amount; while multiple durations (first parameter values) of the deduction period may be displayed on the transaction object detail page for the user to choose from if the first deduction item is the deduction period (It is also possible to provide a blank field on the transaction object detail page for the user to fill in a limit or a duration. It should be noted that any manner of providing multiple first parameter values on the transaction object detail page shall fall within the protection scope of the present disclosure, and the specific form of the provided first parameter values is not limited).

For the first form of the resource deduction information, step S104 may be specifically implemented as follows: receiving, on the transaction object detail page, a first parameter value of the first deduction item selected by the user according to the resource deduction information.

A limit (first parameter value) selected by the user is received on the transaction object detail page if the first deduction item is the deduction amount. A duration (first parameter value) selected by the user is received on the transaction object detail page if the first deduction item is the deduction period.

In the first form, after the terminal receives the first parameter value of the first deduction item, a related server (such as the second server) needs to determine a corresponding second parameter value of a second deduction item according to the first parameter value and send the second parameter value to the terminal. Then, the terminal may determine a parameter pair used as the resource deduction mode according to the first parameter value and the second parameter value. Therefore, after step S104 and before step S106, the following step 1 and step 2 may be further performed:

Step 1: The first parameter value of the first deduction item received in S104 is sent.

In step 1, the terminal may send the first parameter value of the first deduction item to the second server directly. In order to further guarantee the security, it is also possible to send the first parameter value of the first deduction item to the first server, to instruct the first server to send the first parameter value to the second server.

On the assumption that the first deduction item is the deduction amount, multiple limits (first parameter values) of the deduction amount that may be displayed on the transaction object detail page are 500 yuan to 10000 yuan, and the user-selected amount received in step S104 is 2000 yuan, the first parameter value (2000 yuan) may be sent to the related server in step 1. On the assumption that the first deduction item is the deduction period, multiple durations (first parameter values) of the deduction period that may be displayed on the transaction object detail page are 10 days to 365 days, and the user-selected duration received in step S104 is 90 days, the first parameter value (90 days) may be sent to the related server in step 1.

In a specific implementation, different identifiers may be set for the deduction amount or the deduction period. The server end may determine whether the first parameter value sent by the terminal is a limit or a duration according to the identifier.

Step 2: A second parameter value of a second deduction item corresponding to the first parameter value is received, wherein the second deduction item is either the deduction amount or the deduction period and is different from the first deduction item.

In step 2, the second deduction item is either the deduction amount or the deduction period and is different from the first deduction item. In other words, the second deduction item is the deduction period when the first deduction item is the deduction amount, and the second deduction item is the deduction amount when the first deduction item is the deduction period.

In step 2, the second parameter value sent by the second server may be received directly, or the second parameter value sent by the second server may be received through the first server.

After receiving the first parameter value sent by the terminal, a related server (such as the second server) may determine a corresponding second parameter value according to the first parameter value and a current real-time dynamic income, and feedback the second parameter value to the terminal. Refer to the subsequent related example embodiment for a specific determining method.

On the assumption that the first deduction item is the deduction amount, the user-selected amount received in step S104 is 2000 yuan, and the related server determines that the corresponding duration is 60 days, information about the duration is fed back to the terminal. On the assumption that the first deduction item is the deduction period, the user-selected duration received in step S104 is 90 days, and the related server determines that the corresponding limit is 1500 yuan, information about the limit is fed back to the terminal.

Second form: the resource deduction information includes multiple different resource deduction modes, and each resource deduction mode is represented by a limit of a deduction amount and a duration of a deduction period corresponding to the limit of the deduction amount.

For the second form of the resource deduction information, a related server directly determines parameter pairs representing different resource deduction modes. That is, each of the resource deduction modes is represented by a limit of a deduction amount and a corresponding duration of a deduction period, and is sent to the terminal. The user may directly choose from the resource deduction modes with combined parameter pairs. Preferably, the resource deduction mode with a combined parameter pair is also determined by the related server according to the price of the transaction object and the current real-time dynamic income.

For the second form of the resource deduction information, step S104 may be specifically implemented as follows: receiving, on the transaction object detail page, a limit of a deduction amount selected by the user according to the resource deduction information and a duration of a deduction period corresponding to the deduction amount.

It is assumed that multiple resource deduction modes which may be displayed on the transaction object detail page are: a 500-yuan limit of the deduction amount with a 12-month duration of the deduction period, a 1000-yuan limit of the deduction amount with an 8-month duration of the deduction period, a 5000-yuan limit of the deduction amount with a 5-month duration of the deduction period, a 10000-yuan limit of the deduction amount with a 3-month duration of the deduction period, and so on. Then, the user may select a needed resource deduction mode from the limit-duration-combined resource deduction modes on the transaction object detail page according to his/her own condition. Assuming that a resource deduction mode which may be selected by the user is a 5000-yuan limit of the deduction amount with a 5-month duration of the deduction period, the terminal may receive the selection of the user on the transaction object detail page in step S104.

S106: A resource deduction request is generated according to the selected resource deduction mode and sent, so that the network server carries out resource deduction according to the resource deduction request.

In step S106, the generated resource deduction request may carry the selected resource deduction mode and may be used for informing the terminal on the network server to confirm the selected resource deduction mode. Step S106 may have different implementations corresponding to different forms of the resource deduction information introduced in S104. The implementations are introduced below one by one:

For the first form of the resource deduction information introduced in step S104, step S106 may be specifically implemented as follows: when the second parameter value of the second deduction item has been confirmed, generating a resource deduction request according to the selected first parameter value of the first deduction item and the confirmed second parameter value of the second deduction item, and sending the resource deduction request.

In this implementation, the terminal may display the received second parameter value determined by the related server on the transaction object detail page. When the user may accept a resource deduction mode consisting of the first parameter value and the second parameter value, the resource deduction mode may be determined as the payment mode, that is, a resource deduction request generated according to the selected first parameter value of the first deduction item and the confirmed second parameter value of the second deduction item is sent to a related server (such as the second server). When the user cannot accept the resource deduction mode consisting of the first parameter value and the second parameter value, a new first parameter value may be selected, and steps 1 to 2 in S104 are repeated till the user may accept a resource deduction mode which is fed back by the related server and consists of a first parameter value and a second parameter value.

Assuming that the resource deduction mode based on the information fed back by the related server, i.e., the deduction amount is 2000 yuan and the deduction period is 60 days, is unacceptable to the user, the user may select a new deduction amount on the transaction object detail page, such as 1500 yuan, and feedback the selected new amount information to the related server (the second server). The related server may determine new corresponding duration information according to the received new amount information, and feedback the duration information to the terminal. Assuming that the duration is 90 days, if the user may accept the resource deduction mode consisting of the 1500-yuan deduction amount and 90-day deduction period, a resource deduction request may be sent to the related server. If the user still cannot accept the resource deduction mode, steps 1 to 2 in S104 may be further repeated till the user may accept a resource deduction mode which is fed back by the related server and consists of a limit and a duration.

For the second form of the resource deduction information introduced in S104, step S106 may be specifically implemented as follows: generating a resource deduction request according to the selected limit of the deduction amount and the duration of the deduction period corresponding to the deduction amount, and sending the resource deduction request.

In this implementation, the received resource deduction mode selected by the user, i.e., the limit of the deduction amount and the duration of the deduction period corresponding to the deduction amount, is sent to the related server.

Moreover, in spite of the first form or the second form of the resource deduction information introduced in step S104, the resource deduction request may be sent to the first server at a network, to instruct the first server to inform the second server to carry out resource deduction according to the resource deduction request; or the resource deduction request may be sent to the second server at the network directly, so that the second server carries out resource deduction according to the resource deduction request.

In this example embodiment, the terminal may further send a transaction object acquisition request to the first server when the service and the payment are provided by different servers respectively. Moreover, the operation of sending a resource deduction request after the user confirms the resource deduction mode and the operation of sending a transaction object acquisition request may be one integrated operation or may be two separate operations. In other words, different buttons or one button for determining a resource deduction mode and sending a transaction object acquisition request may be set on the transaction object detail page in a specific implementation. If one button (for example, a “buy now” button) is set, the terminal may send the determined resource deduction mode to the second server and send a transaction object acquisition request to the first server upon reception of a clicking operation on the button.

This example embodiment may further include a step of receiving the provided transaction object. The transaction object may be provided for the terminal by a related server (such as the first server). Assuming that the transaction object is a commodity, a merchant may arrange delivery of the commodity to the user, i.e., provide the transaction object after the user completes the payment.

A second example embodiment:

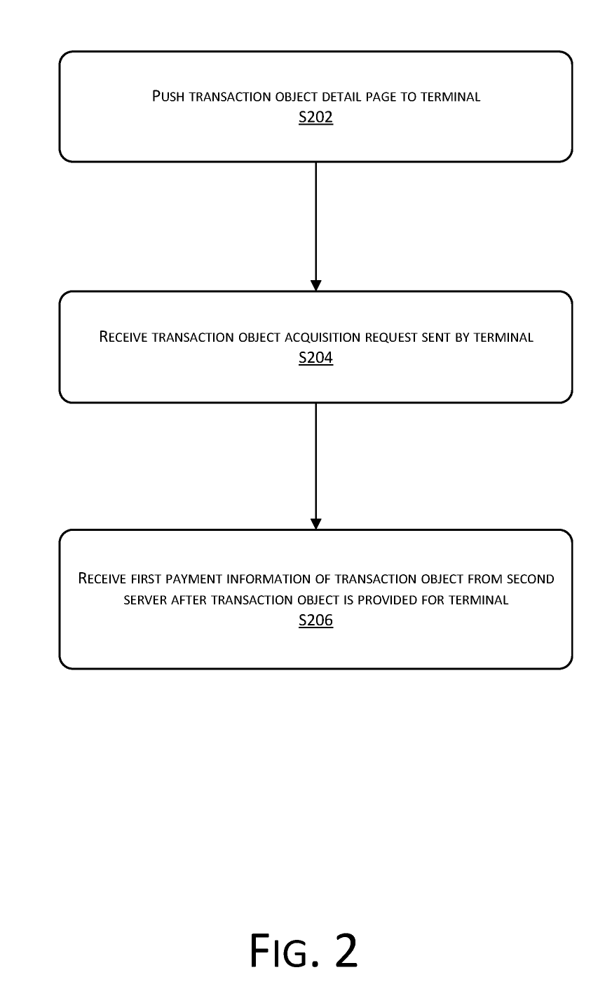

The second example embodiment of the present disclosure provides a transaction object providing method applied to a first server. As shown in FIG. 2, the method includes the following steps:

S202: A transaction object detail page is pushed to a terminal, wherein the transaction object detail page includes resource deduction information, and a resource deduction mode represented by the resource deduction information is used for replacing a payment mode of directly paying for a transaction object corresponding to the transaction object detail page.

S204: A transaction object acquisition request sent by the terminal is received.

S206: First payment information of the transaction object is received from a second server after the transaction object is provided for the terminal.

A third example embodiment:

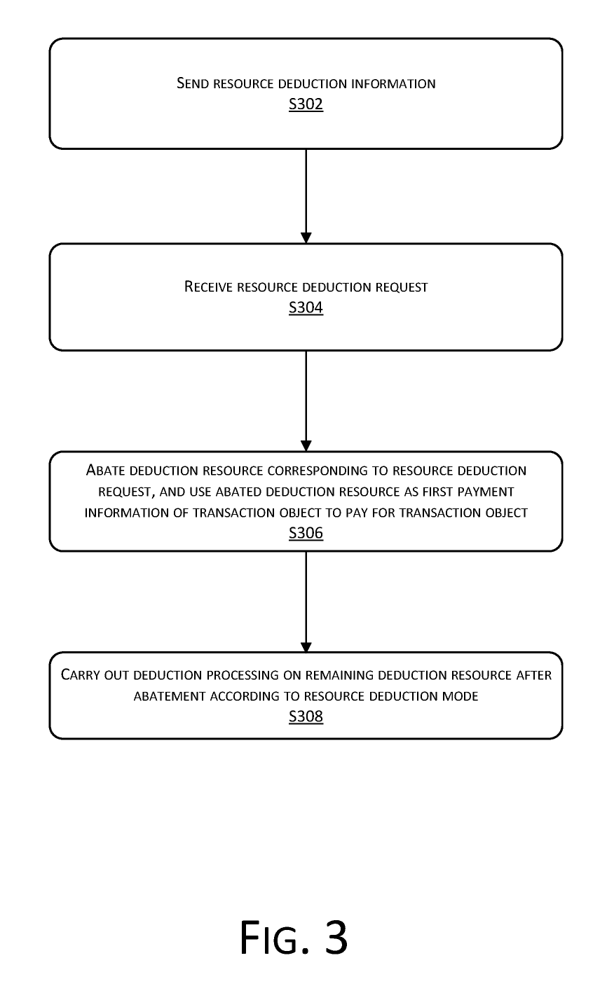

The third example embodiment of the present disclosure provides a transaction object providing method applied to a second server. As shown in FIG. 3, the method includes the following steps:

S302: Resource deduction information is sent, wherein the resource deduction information is displayed on a transaction object detail page, and a resource deduction mode represented by the resource deduction information is used for replacing a payment mode of directly paying for a transaction object corresponding to the transaction object detail page.

A step of determining the resource deduction information may be further performed before step S302. In this case, it is necessary to acquire price information of the transaction object. That is, step 1 may be performed first:

Step 1: Price information corresponding to the transaction object is obtained when the terminal receives the transaction object detail page.

In the example embodiment of the present disclosure, the price information corresponding to the transaction object, details of the transaction object, and other information may be determined by a first server, added to the transaction object detail page, and sent to the terminal. The resource deduction information may not be determined by the first server. A payment information invoking module may be set on the transaction object detail page. When the terminal receives the transaction object detail page (for example, when the terminal opens a transaction object detail page of a certain commodity), the payment information invoking module is triggered to connect to the second server and send the price information corresponding to the transaction object on the transaction object detail page to the second server, so that the second server may determine resource deduction information according to the price information and a current dynamic income. Alternatively, no payment information invoking module is set, and the first server sends the price information of the transaction object to the second server when the terminal receives the transaction object detail page.

It is assumed that a merchant of a transaction object edits a transaction object detail page for the transaction object, including the price of the transaction object (such as 99 yuan), detail information, and so on, and pushes the transaction object detail page of the transaction object to the terminal through the first server. The transaction object detail page received by the terminal does not carry resource deduction information, and a payment information invoking module carried on the transaction object detail page is triggered to send the price of the transaction object to the second server. The second transaction server determines resource deduction information and provides the determined information to the transaction object detail page for displaying. Alternatively, the first server sends the price information to the second server.

Step S302 may have different implementations corresponding to different forms of the resource deduction information introduced in S104:

For the first form of the resource deduction information, step S302 may be specifically implemented as follows: sending a first deduction item and different first parameter values of the first deduction item to the terminal, wherein the first parameter value is a limit when the first deduction item is a deduction amount, and the first parameter value is a duration when the first deduction item is a deduction period.

In the first form of the resource deduction information, the resource deduction information may include different first parameter values corresponding to a deduction item (the first deduction item), and the multiple different first parameter values of the first deduction item are displayed on the transaction object detail page as resource deduction information in many manners, for example, multiple discrete first parameter values for the user to choose from, a continuous range of first parameter values for the user to choose from, a blank for the user to fill in, and so on. The display manner is not limited here.

The first parameter value is a limit when the first deduction item is a deduction amount, and the first parameter value is a duration when the first deduction item is a deduction period. Assuming that the price of the transaction object on the transaction object detail page is 99 yuan, the first parameter values (limits) may be continuous or discrete values from 500 yuan to 10000 yuan when the first deduction item is the deduction amount, and the first parameter values (durations) may be continuous or discrete values from 1 month to 1 year when the first deduction item is the deduction period.

The first parameter value may be determined according to the price information obtained in step 1. Different price information may correspond to different first parameter values. For example, a 10-yuan price may correspond to multiple limits from 5 to 100 yuan, a 1000-yuan price may correspond to multiple limits from 500 to 5000 yuan, and so on.

For the first form of the resource deduction information, steps 2 to 4 may be further performed before step S304 because only different first parameter values of the first deduction item are sent in step S302:

Step 2: A first parameter value of the first deduction item sent by the terminal is received.

After the resource deduction information (multiple first parameter values of the first deduction item) is displayed on the transaction object detail page, in step 2, the user may select an appropriate first parameter value according to his/her own condition; the terminal receives the first parameter value selected by the user and sends the first parameter value to the second server, so that the second server determines a corresponding second parameter value according to the first parameter value.

Step 3: A second parameter value of a second deduction item corresponding to the first parameter value is determined according to the price information, wherein the second deduction item is either the deduction amount or the deduction period and is different from the first deduction item.

In step 3, when the first deduction item is the deduction amount, a duration (second parameter value) of a deduction period (second deduction item) is determined according to the limit (first parameter value); when the first deduction item is the deduction period, a limit (second parameter value) of a deduction amount (second deduction item) is determined according to the duration (first parameter value).

Refer to step S308 for details of the specific determining manner in step 3. It is necessary to ensure in step 3 that the resource deduction mode consisting of the determined second parameter value and the first parameter value may produce a value at least equivalent to the transaction object by pledging the limit corresponding to the deduction amount for the duration corresponding to the deduction period.

Step 4: The second parameter value of the second deduction item is sent to the terminal.

In step 4, the determined second parameter value is sent to the terminal and displayed on the transaction object detail page, so that the user using the terminal may determine whether the second parameter value is acceptable.

It is assumed that the corresponding price of the transaction object on the transaction object detail page is 99 yuan, the first deduction item is the deduction amount, the first parameter values (limits) are continuous values from 500 yuan to 10000 yuan, and the amount selected by the user is 2000 yuan. According to step 2, the second server receives 2000 yuan sent by the terminal. According to step 3, the second server determines a duration corresponding to the second deduction item (deduction period) based on the price information 99 yuan and a current dynamic income. Assuming that the duration is 60 days, in step 4, the second server may send the determined second parameter value (60 days) to the terminal. The principle is the same when the first deduction item is the deduction period, and details are not described here again.

In order to further improve the security, the terminal may communicate with the second server through a first server instead of directly communicating with the second server. In this case, for the first form of the resource deduction information, step S302 may be specifically implemented as follows: sending a first deduction item and different first parameter values of the first deduction item to the first server, to instruct the first server to send the first deduction item and the different first parameter values of the first deduction item to the terminal, wherein the first parameter value is a limit when the first deduction item is a deduction amount, and the first parameter value is a duration when the first deduction item is a deduction period.

Correspondingly, step 2 may be implemented as follows: receiving a first parameter value of the first deduction item selected by the terminal and forwarded by the first server.

Step 4 may be implemented as follows: sending the second parameter value of the second deduction item to the first server, to instruct the first server to send the second parameter value of the second deduction item to the terminal, wherein the second deduction item is either the deduction amount or the deduction period and is different from the first deduction item.

For the second form of the resource deduction information, step S302 may be specifically implemented as follows: sending the resource deduction information to the terminal, wherein the resource deduction information includes multiple different resource deduction modes.

In the second form of the resource deduction information, the resource deduction information may include multiple parameter pairs that represent different resource deduction modes, each parameter pair consisting of a deduction amount and a deduction period. The parameter pairs are displayed on the transaction object detail page as the resource deduction information.

Step 5 may be further performed to determine the multiple different parameter pairs before the resource deduction information is sent to the terminal, i.e., before step S302 is performed:

Step 5: Multiple different resource deduction modes are determined according to the price information in step 1, wherein each resource deduction mode is represented by a limit of a deduction amount and a duration of a deduction period corresponding to the limit of the deduction amount.

Refer to step S308 for details of the specific determining manner in step 5.

In order to further improve the security, the terminal may communicate with the second server through a first server instead of directly communicating with the second server. In this case, for the second form of the resource deduction information, step S302 may be specifically implemented as follows: sending the resource deduction information to the first server, to instruct the first server to send the resource deduction information to the terminal, wherein the resource deduction information includes the multiple different resource deduction modes.

S304: A resource deduction request is received, wherein the resource deduction request is generated by the terminal based on a resource deduction mode that the user selects according to the resource deduction information.

For the first form of the resource deduction information, step S304 may be specifically implemented as follows: when the terminal has confirmed the received second parameter value, receiving a resource deduction request that is generated according to the first parameter value of the first deduction item and the second parameter value of the second deduction item and sent by the terminal; or

when the terminal has confirmed the received second parameter value, receiving a resource deduction request that is generated by the terminal according to the first parameter value of the first deduction item and the second parameter value of the second deduction item and forwarded by the first server.

When the terminal has confirmed the received second parameter value, the received resource deduction request may carry the first parameter value of the first deduction item and the second parameter value of the second deduction item.

The user obtains, on the transaction object detail page, the resource deduction mode consisting of the first parameter value selected by the user and the second parameter value fed back by the second server. When the resource deduction mode is acceptable, the user may send confirmation information to the second server, i.e., confirming payment based on the resource deduction mode consisting of the first parameter value of the first deduction item and the second parameter value of the second deduction item. When the resource deduction mode is unacceptable, the steps of sending the first parameter value and receiving the corresponding second parameter value are repeated, till the terminal may accept the received second parameter value. Then, the second server may receive the resource deduction request sent by the terminal.

In addition, this step may also trigger the first server to receive a transaction object acquisition request sent by the terminal. In other words, when confirming the resource deduction mode to be used as a payment mode, the terminal may send a resource deduction request for the resource deduction mode to the second server, and may send a transaction object acquisition request to the first server (step S204 in FIG. 2).

For the second form of the resource deduction information, the resource deduction mode carried by the resource deduction request received in step S304 includes a suitable parameter pair selected by the terminal directly according to the parameter pairs provided on the transaction object detail page.

S306: A deduction resource corresponding to the resource deduction request in S304 is abated, and the abated deduction resource is used as first payment information of the transaction object to pay for the transaction object.

Steps 6 to 7 may be further performed before step S306:

Step 6: Second payment information corresponding to the limit of the deduction amount corresponding to the resource deduction mode is received, the second payment information being sent by a preset payment account under the control of the terminal.

In the conventional payment mode, the terminal may control the preset payment account to make a payment according to the corresponding price of the transaction object. Unlike the conventional payment mode, in the transaction object providing method provided by the present disclosure, the terminal may control the preset payment account to make a payment according to the corresponding limit of the deduction amount in the determined resource deduction mode.

The preset payment account may be any payment account, such as a bank account, or a third-party account (such as an ALIPAY™ account) provided by the second server. The limit corresponding to the deduction amount may be deducted from the preset payment account directly when the preset payment account is a preset third-party payment account of the user. When the preset payment account is an account other than a third-party account, the terminal needs to control the preset payment account other than the third-party payment account to make a payment to a preset third-party payment account, and the second server carries out subsequent deduction processing on the second payment information.

In step 6, a notification message may be sent to the first server after the user completes the payment and the second server receives the second payment information, to notify the first server that the state of the terminal has changed to a payment-completed state. The first server may provide the payment-free transaction object to the user according to the state information, i.e., step S206 in FIG. 2 may be performed.

Step 7: A start time point of timing is determined, and timing is started.

The start time point in step 7 may be used as a start time point of the duration corresponding to the deduction period, and may also be used as a start time point of a subsequent preset period of time. The preset period of time is used for determining whether feedback information sent by the terminal after acquiring the transaction object is received within the preset period of time.

Then, step S306 may be specifically implemented as steps 8 to 10:

Step 8: It is determined whether the first server receives feedback information within a preset period of time starting from the start time point determined in step 7, the feedback information being sent by the terminal after acquiring the transaction object.

In the example embodiment of the present disclosure, the second server receives the second payment information. The second server needs to send the first payment information corresponding to the transaction object in the second payment information to the first server subsequently, to pay for the transaction object. A value-added service is provided for the remaining second payment information without the first payment information, to produce a value at least equivalent to the first payment information. The second server may split the second payment information into a part for payment and a part for the value-added service based on the following triggering condition: if feedback information sent by the terminal after acquiring the transaction object is received within the preset period of time starting from the start time point, step 9 to step S308 are triggered to be performed; or if no feedback information sent by the terminal is received within the preset period of time starting from the start time point and an end time point of the preset period of time arrives, step 10 to step S308 are triggered to be performed.

In the example embodiment of the present disclosure, the first server may send a notification message to the second server when receiving the feedback information sent by the terminal after acquiring the transaction object, to notify the second server that the state of the terminal has changed to a state that the transaction object has been acquired and information has been fed back. The second server may determine the subsequent step according to the state information.

Step 9: If the feedback information is received, the first payment information corresponding to the transaction object is abated from the second payment information, and the first payment information is sent to the first server.

Step 10: If no feedback information is received, the first payment information corresponding to the transaction object is abated from the second payment information when an end time point of the preset period of time arrives, and the first payment information is sent to the first server.

S308: Deduction processing is carried out on the remaining deduction resource after the abatement according to the resource deduction mode.

Step S308 may be specifically implemented as follows: providing a value-added service for the remaining second payment information without the first payment information after the first payment information is sent to the first server and before the duration of the deduction period starting from the start time point and corresponding to the resource deduction mode comes to an end.

The example embodiment of the present disclosure provides a resource deduction mode different from the conventional direct payment mode, to complete the payment for the transaction object. Although the user does not need to make a payment directly in the resource deduction mode provided in the example embodiment of the present disclosure, it is still necessary to compensate a provider of the transaction object. Therefore, a value-added transaction object may be provided based on two periods of time:

The first period of time may start from a moment when the second payment information which is corresponding to the limit of the deduction amount corresponding to the resource deduction mode and sent by the preset payment account under the control of the terminal is received (corresponding to step 6), and last till the first server receives the feedback information sent by the terminal after acquiring the transaction object, or till the end time point of the preset period of time. In the first period of time, the second server obtains the second payment information corresponding to the deduction limit. Then, the second server may provide a value-added service for the second payment information in the first period of time according to a current real-time first dynamic income, to produce a first value.

The second period of time may start from the moment when the first server receives the feedback information sent by the terminal after acquiring the transaction object or start from the end time point of the preset period of time, and last till an end time point of the deduction period. In the second period of time, the second server obtains the remaining second payment information without the first payment information corresponding to the transaction object. Then, the second server may provide a value-added service for the remaining part in the second period of time according to a current real-time second dynamic income, to produce a second value.

Therefore, the second server may pay for the transaction object provided that a sum of the first value and the second value is not less than the first payment information corresponding to the transaction object, as shown in Formula (1), so that the user may obtain the transaction object without making a payment:

first payment information corresponding to the transaction object<=second payment information×first dynamic income×first period of time+(second payment information−first payment information)×second dynamic income×second period of time Formula (1).

Formula (1) is transformed to Formula (2):

first payment information corresponding to the transaction object<=first payment information×first dynamic income×first period of time+(second payment information−first payment information)×first dynamic income×first period of time+(second payment information−first payment information)×second dynamic income×second period of time Formula (2).

Since the second dynamic income is greater than or equal to the first dynamic income, and a sum of the first period of time and the second period of time is the duration corresponding to the deduction period, Formula (2) may be transformed to Formula (3):

first payment information corresponding to the transaction object<=first payment information×first dynamic income×first period of time+(second payment information−first payment information)×second dynamic income×duration corresponding to the deduction period Formula (3).

As may be seen, if Formula (4) is satisfied:

first payment information corresponding to the transaction object=(second payment information−first payment information)×second dynamic income×duration corresponding to the deduction period Formula (4),

the second server may pay for the transaction object, so that the user may obtain the transaction object without making a payment.

Then, the second parameter value of the second deduction item may be determined according to the first parameter value corresponding to the first deduction item based on Formula (4) in a specific implementation of step 3, so that the resource deduction mode, represented by the first parameter value and the second parameter value, for the preset payment account may produce a value at least equivalent to the transaction object.

For step 3, a duration value corresponding to the second deduction item, i.e., a deduction period may be determined based on Formula (5) when the first deduction item is a deduction amount:

duration corresponding to the deduction period=first payment information corresponding to the transaction object/[(second payment information−first payment information)×second dynamic income] Formula (5).

That is, step 3 may be specifically implemented as follows: when the first deduction item is the deduction amount, the second deduction item is the deduction period, and a duration of the deduction period is a quotient of the price information divided by a first product, wherein the first product is a product of a current dynamic income multiplied by a difference between a limit of the deduction amount and the price information.

A limit value corresponding to the second deduction item, i.e., a deduction amount may be determined based on Formula (6) when the first deduction item is a deduction period:

second payment information=(first payment information corresponding to the transaction object/second dynamic income×control period of time)+first payment information Formula (6).

That is, step 3 may be specifically implemented as follows: when the first deduction item is the deduction period, the second deduction item is the deduction amount, and a limit of the deduction amount is a sum between the price information and a quotient of the price information divided by a second product, wherein the second product is a product of a current dynamic income multiplied by a duration of the deduction period.

Based on step S308, step 5 may be specifically implemented as follows:

determining different limits of a preset number of deduction amounts; and for each limit, determining a quotient of the price information divided by a first product as a duration of a deduction period corresponding to the limit, wherein the first product is a product of a current dynamic income multiplied by a difference between the limit value and the price information; or

determining different durations of a preset number of deduction periods; and for each duration, determining a sum between the price information and a quotient of the price information divided by a second product as a limit of a deduction amount corresponding to the duration, wherein the second product is a product of a current dynamic income multiplied by the duration.

In step 5, different limits of a preset number of deduction amounts may be determined first, and different durations corresponding to the different limits may be determined based on the determined different limits, the price information corresponding to the transaction object and the current dynamic income, to obtain multiple different resource deduction modes. Alternatively, different durations of a preset number of deduction periods may be determined first, and different limits corresponding to the different durations may be determined based on the determined different durations, the price information corresponding to the transaction object and the current dynamic income, to obtain multiple different resource deduction modes. Each resource deduction mode obtained may produce a value at least equivalent to the corresponding transaction object on the transaction object detail page.

The method may further include step 11 after a duration starting from the start time point comes to an end:

Step 11: Third payment information corresponding to the limit of the deduction amount corresponding to the resource deduction mode is sent to the preset account, wherein the duration is the duration of the deduction period corresponding to the resource deduction mode.

In step 11, when the duration corresponding to the deduction period comes to an end, the limit corresponding to the deduction amount is returned to the user according to the resource deduction mode confirmed by the user. As may be seen, the preset payment account of the user does not suffer any loss. In other words, the user acquires the transaction object without making a payment.

Based on the same concept, the example embodiments of the present disclosure further provide a terminal and related server. The terminal and related server employ a solution with a principle similar to that of the previous transaction object providing method. Therefore, reference may be made to the foregoing implementation of the method for the implementation of the terminal and related server. Repeated parts are not described again.

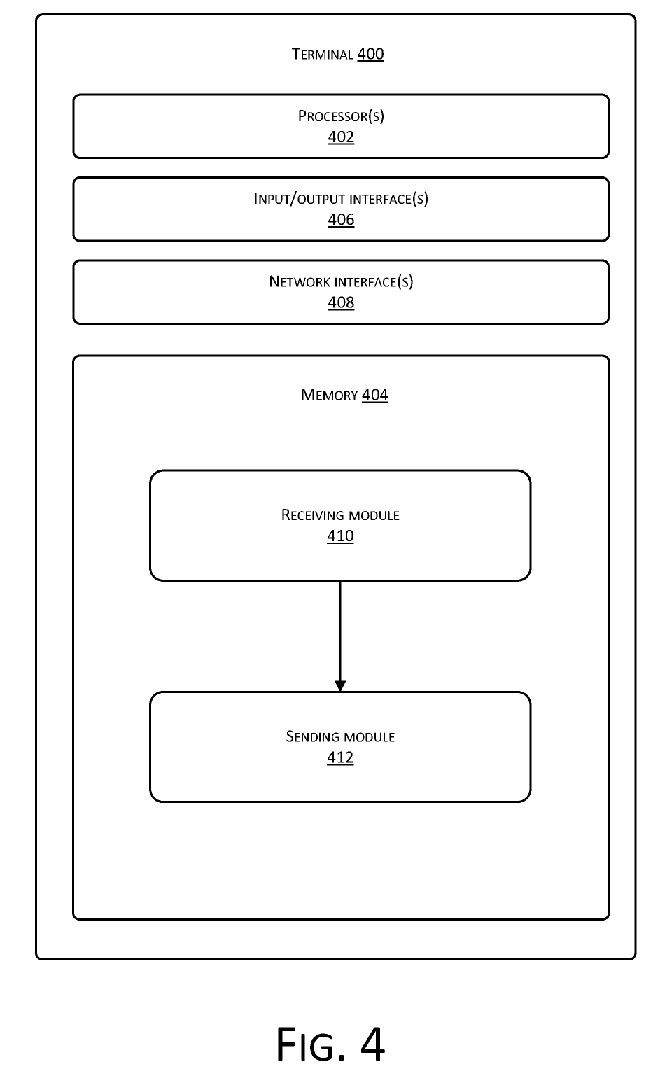

As shown in FIG. 4, a terminal 400 provided by an example embodiment of the present disclosure includes one or more processor(s) 402 or data processing unit(s) and memory 404. The terminal 400 may further include one or more input/output interface(s) 406 and one or more network interface(s) 408. The memory 404 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 404 may store therein a plurality of modules or units including:

a receiving module 410 configured to receive a transaction object detail page pushed by a network server, wherein the transaction object detail page includes resource deduction information, and a resource deduction mode represented by the resource deduction information is used for replacing a payment mode of directly paying for a transaction object corresponding to the transaction object detail page; and receive, on the transaction object detail page, a resource deduction mode selected by a user according to the resource deduction information; and

a sending module 412 configured to generate a resource deduction request according to the selected resource deduction mode and send the resource deduction request, so that the network server carries out resource deduction according to the resource deduction request.

Further, the sending module 412 is specifically configured to: generate a resource deduction request according to the selected resource deduction mode and send the resource deduction request to a first server at a network, to instruct the first server to inform a second server to carry out resource deduction according to the resource deduction request; or

generate a resource deduction request according to the selected resource deduction mode and send the resource deduction request to a second server at the network, so that the second server carries out resource deduction according to the resource deduction request.

Further, the receiving module 410 is specifically configured to receive a transaction object detail page pushed by a first server at a network; and

the first server sends price information of the transaction object to a second server when the terminal receives the transaction object detail page, so that the second server determines the resource deduction information according to the price information and a current real-time dynamic income, and feeds back the determined resource deduction information to the first server; and the first server sends the resource deduction information to the transaction object detail page for displaying.

Further, the sending module 412 is further configured to trigger a payment information invoking module to send price information of the transaction object to a second server after the receiving module 410 receives the transaction object detail page pushed by the network server, so that the second server determines the resource deduction information according to the price information and a current real-time dynamic income, and feeds back the determined resource deduction information to the transaction object detail page for displaying, wherein the payment information invoking module is set on the transaction object detail page.

Further, the receiving module 410 is specifically configured to receive, on the transaction object detail page, a limit of a deduction amount selected by the user according to the resource deduction information and a duration of a deduction period corresponding to the deduction amount, the resource deduction information including multiple different resource deduction modes, and each resource deduction mode being represented by a limit of a deduction amount and a duration of a deduction period corresponding to the limit of the deduction amount; and

the sending module 412 is specifically configured to generate a resource deduction request according to the selected limit of the deduction amount and the duration of the deduction period corresponding to the deduction amount, and send the resource deduction request.

Further, the receiving module 410 is specifically configured to receive, on the transaction object detail page, a first parameter value of a first deduction item selected by the user according to the resource deduction information, the resource deduction information including the first deduction item and different first parameter values of the first deduction item, wherein the first parameter value is a limit when the first deduction item is a deduction amount, and the first parameter value is a duration when the first deduction item is a deduction period;

the sending module 412 is further configured to send the first parameter value of the first deduction item before generating the resource deduction request according to the selected resource deduction mode and sending the resource deduction request;

the receiving module 410 is further configured to receive a second parameter value of a second deduction item corresponding to the first parameter value, wherein the second deduction item is either the deduction amount or the deduction period and is different from the first deduction item; and

the sending module 412 is specifically configured to: when the second parameter value of the second deduction item has been confirmed, generate a resource deduction request according to the selected first parameter value of the first deduction item and the confirmed second parameter value of the second deduction item, and send the resource deduction request.

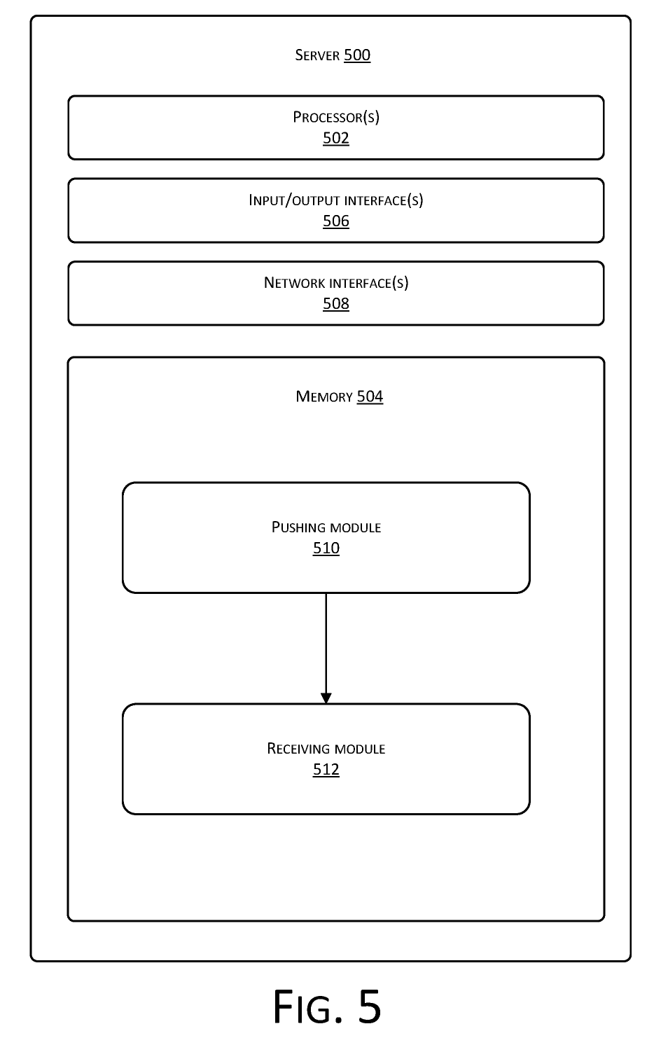

As shown in FIG. 5, a server 500 provided in an example embodiment of the present disclosure serves as a first server includes one or more processor(s) 502 or data processing unit(s) and memory 504. The server 500 may further include one or more input/output interface(s) 506 and one or more network interface(s) 508. The memory 504 is an example of computer readable media.

The memory 504 may store therein a plurality of modules or units including:

a pushing module 510 configured to push a transaction object detail page to a terminal, wherein the transaction object detail page includes resource deduction information, and a resource deduction mode represented by the resource deduction information is used for replacing a payment mode of directly paying for a transaction object corresponding to the transaction object detail page; and

a receiving module 512 configured to receive a transaction object acquisition request sent by the terminal; and receive first payment information of the transaction object from a second server after the transaction object is provided for the terminal.

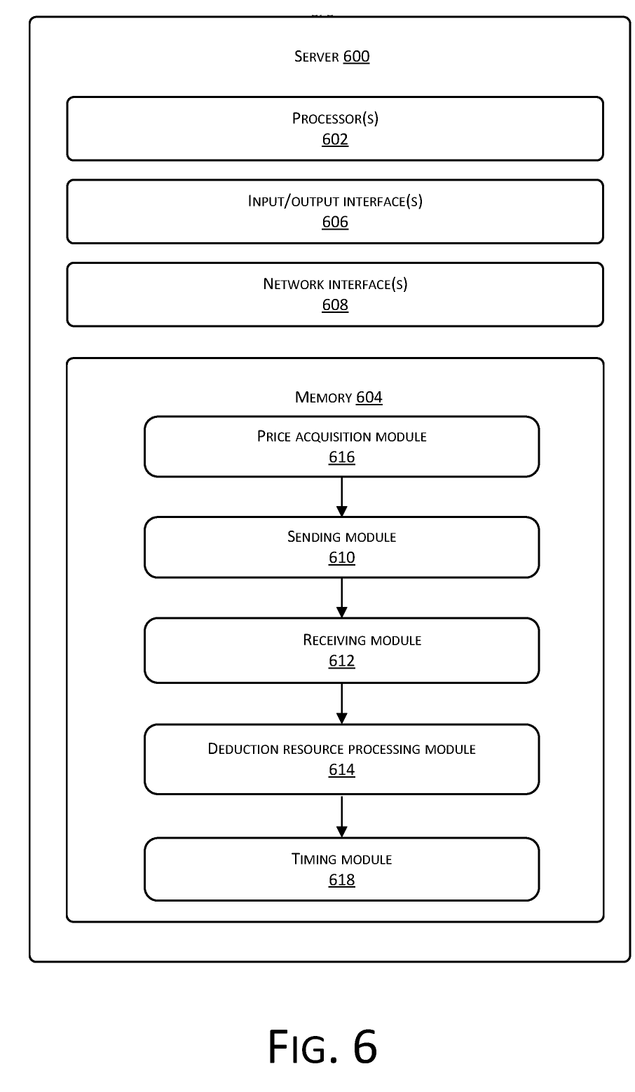

As shown in FIG. 6, a server 600 provided in an example embodiment of the present disclosure serves as a second server includes one or more processor(s) 602 or data processing unit(s) and memory 604. The server 600 may further include one or more input/output interface(s) 606 and one or more network interface(s) 608. The memory 604 is an example of computer readable media.

The memory 604 may store therein a plurality of modules or units including:

a sending module 610 configured to send resource deduction information to a terminal, wherein the resource deduction information is displayed on a transaction object detail page, and a resource deduction mode represented by the resource deduction information is used for replacing a payment mode of directly paying for a transaction object corresponding to the transaction object detail page;

a receiving module 612 configured to receive a resource deduction request, wherein the resource deduction request is generated by the terminal based on a resource deduction mode that a user selects according to the resource deduction information; and

a deduction resource processing module 614 configured to abate a deduction resource, and use the abated deduction resource as first payment information of the transaction object to pay for the transaction object; and carry out deduction processing on the remaining deduction resource after the abatement according to the resource deduction mode.

Further, the server 600 may include a price acquisition module 616 stored on the memory 604;

the price acquisition module 616 is configured to: before the sending module 610 sends the resource deduction information, obtain price information corresponding to the transaction object when the terminal receives the transaction object detail page;

the deduction resource processing module 614 is further configured to determine multiple different resource deduction modes according to the price information, wherein each resource deduction mode is represented by a limit of a deduction amount and a duration of a deduction period corresponding to the limit of the deduction amount; and

the sending module 610 is specifically configured to send the resource deduction information to the terminal; or send the resource deduction information to a first server, to instruct the first server to send the resource deduction information to the terminal, wherein the resource deduction information includes the multiple different resource deduction modes.

Further, the deduction resource processing module 614 is specifically configured to: determine different limits of a preset number of deduction amounts; and for each limit, determine a quotient of the price information divided by a first product as a duration of a deduction period corresponding to the limit, wherein the first product is a product of a current real-time dynamic income multiplied by a difference between the limit value and the price information; or

determine different durations of a preset number of deduction periods; and for each duration, determine a sum between the price information and a quotient of the price information divided by a second product as a limit of a deduction amount corresponding to the duration, wherein the second product is a product of a current real-time dynamic income multiplied by the duration.

Further, the server 600 may include a price acquisition module 616;

the price acquisition module 616 is configured to: before the sending module 610 sends the resource deduction information, obtain price information corresponding to the transaction object when the terminal receives the transaction object detail page;

the sending module 610 is specifically configured to send a first deduction item and different first parameter values of the first deduction item to the terminal, wherein the first parameter value is a limit when the first deduction item is a deduction amount, and the first parameter value is a duration when the first deduction item is a deduction period;

the receiving module 612 is further configured to: before receiving the resource deduction request, receive a first parameter value of the first deduction item sent by the terminal;

the deduction resource processing module 614 is further configured to determine a second parameter value of a second deduction item corresponding to the first parameter value according to the price information;

the sending module 610 is further configured to send the second parameter value of the second deduction item to the terminal, wherein the second deduction item is either the deduction amount or the deduction period and is different from the first deduction item; and

the receiving module 612 is specifically configured to: when the terminal has confirmed the received second parameter value, receive a resource deduction request that is generated according to the first parameter value of the first deduction item and the second parameter value of the second deduction item and sent by the terminal.

Further, the server 600 may include a price acquisition module 616;

the price acquisition module 616 is configured to: before the sending module 610 sends the resource deduction information, obtain price information corresponding to the transaction object when the terminal receives the transaction object detail page;

the sending module 610 is specifically configured to send a first deduction item and different first parameter values of the first deduction item to a first server, to instruct the first server to send the first deduction item and the different first parameter values of the first deduction item to the terminal, wherein the first parameter value is a limit when the first deduction item is a deduction amount, and the first parameter value is a duration when the first deduction item is a deduction period;

the receiving module 612 is further configured to: before receiving the resource deduction request, receive a first parameter value of the first deduction item selected by the terminal and forwarded by the first server;

the deduction resource processing module 614 is further configured to determine a second parameter value of a second deduction item corresponding to the first parameter value according to the price information;

the sending module 610 is further configured to send the second parameter value of the second deduction item to the first server, to instruct the first server to send the second parameter value of the second deduction item to the terminal, wherein the second deduction item is either the deduction amount or the deduction period and is different from the first deduction item; and

the receiving module 612 is specifically configured to: when the terminal has confirmed the received second parameter value, receive a resource deduction request that is generated by the terminal according to the first parameter value of the first deduction item and the second parameter value of the second deduction item and forwarded by the first server.

Further, the deduction resource processing module 614 is specifically configured to: when the first deduction item is the deduction amount, the second deduction item is the deduction period, and a duration of the deduction period is a quotient of the price information divided by a first product, wherein the first product is a product of a current real-time dynamic income multiplied by a difference between a limit of the deduction amount and the price information; or

when the first deduction item is the deduction period, the second deduction item is the deduction amount, and a limit of the deduction amount is a sum between the price information and a quotient of the price information divided by a second product, wherein the second product is a product of a current real-time dynamic income multiplied by a duration of the deduction period.

Further, the server 600 may include a timing module 618;

the receiving module 612 is specifically configured to: before the deduction resource processing module 614 abates the deduction resource, receive second payment information corresponding to the limit of the deduction amount corresponding to the resource deduction mode, the second payment information being sent by a preset payment account under the control of the terminal;

the timing module 618 is configured to determine a start time point of timing, and start timing; and

the deduction resource processing module 614 is specifically configured to determine whether the first server receives feedback information within a preset period of time starting from the start time point, the feedback information being sent by the terminal after acquiring the transaction object; if yes, abate the first payment information corresponding to the transaction object from the second payment information, and send the first payment information to the first server; and if no, abate the first payment information corresponding to the transaction object from the second payment information when an end time point of the preset period of time arrives, and send the first payment information to the first server.

Further, the deduction resource processing module 614 is specifically configured to provide a value-added service for the remaining second payment information without the first payment information after the first payment information is sent to the first server and before the duration of the deduction period starting from the start time point and corresponding to the resource deduction mode comes to an end; and

the deduction resource processing module 614 is further configured to send, to the preset account, third payment information corresponding to the limit of the deduction amount corresponding to the resource deduction mode when a duration starting from the start time point comes to an end, wherein the duration is the duration of the deduction period corresponding to the resource deduction mode.

Functions of the foregoing units may correspond to related processing steps in the processes shown in FIG. 1 to FIG. 3, and are not described again here.

Through the description of the implementations above, those skilled in the art may clearly understand that the example embodiments of the present disclosure may be implemented by hardware, or by software plus a necessary universal hardware device. Based on such an understanding, the technical solution of the example embodiments of the present disclosure may be embodied in the form of a software product. The software product may be stored in a non-volatile storage medium (which may be a CD-ROM, a USB flash drive, a removable hard disk, or the like) and includes several instructions to enable a computer device (which may be a personal computer, a server, a network device or the like) to execute the method in each example embodiment of the present disclosure.

Those skilled in the art may understand that the accompanying drawings are merely schematic diagrams of a preferred example embodiment, and modules or processes in the accompanying drawings are not necessarily mandatory to the implementation of the present disclosure.

Those skilled in the art may understand that modules in the apparatus in this example embodiment may be distributed in the apparatus of this example embodiment according to the description of the example embodiment, or variations may be made so that the modules are located in one or more apparatuses different from this example embodiment. The modules in the foregoing example embodiment may be integrated into one module, or may be further split into multiple sub-modules.

Serial numbers of the example embodiments of the present disclosure are merely used for description, and do not mean that an example embodiment is superior or inferior to others.

Apparently, those skilled in the art may make various changes and variations on the present disclosure without departing from the spirit and scope of the present disclosure. Therefore, the present disclosure is also intended to cover these changes and variations if they belong to the claims of the present disclosure and the equivalent technical scope thereof.

The present disclosure may further be understood with clauses as follows.

Clause 1. A transaction object providing method comprising:

receiving a transaction object detail page pushed by a network server, wherein the transaction object detail page comprises resource deduction information, and a resource deduction mode represented by the resource deduction information is used for replacing a payment mode of directly paying for a transaction object corresponding to the transaction object detail page;

receiving, on the transaction object detail page, a resource deduction mode selected by a user according to the resource deduction information; and

generating a resource deduction request according to the selected resource deduction mode and sending the resource deduction request, so that the network server carries out resource deduction according to the resource deduction request.

Clause 2. The method of clause 1, wherein the generating the resource deduction request according to the selected resource deduction mode and sending the resource deduction request comprises:

generating the resource deduction request according to the selected resource deduction mode and sending the resource deduction request to a first server at a network, to instruct the first server to inform a second server to carry out resource deduction according to the resource deduction request; or

generating the resource deduction request according to the selected resource deduction mode and sending the resource deduction request to a second server at the network, so that the second server carries out resource deduction according to the resource deduction request.

Clause 3. The method of clause 1, wherein the receiving the transaction object detail page pushed by a network server comprises:

receiving the transaction object detail page pushed by a first server at a network; and

sending, by the first server, price information of the transaction object to a second server when a terminal receives the transaction object detail page, so that the second server determines the resource deduction information according to the price information and a current real-time dynamic income, and feeds back the determined resource deduction information to the first server, and the first server sends the resource deduction information to the transaction object detail page for displaying.

Clause 4. The method of clause 1, wherein:

a payment information invoking module is set on the transaction object detail page; and

after the receiving the transaction object detail page pushed by the network server, the method further comprises:

triggering the payment information invoking module to send price information of the transaction object to a second server, so that the second server determines the resource deduction information according to the price information and a current real-time dynamic income, and feeds back the determined resource deduction information to the transaction object detail page for displaying.

Clause 5. The method of any of clauses 1 to 4, wherein:

the resource deduction information comprises multiple different resource deduction modes, and each resource deduction mode is represented by a respective limit of a deduction amount and a respective duration of a deduction period corresponding to the limit of the deduction amount;

the receiving, on the transaction object detail page, the resource deduction mode selected by the user according to the resource deduction information specifically comprises:

receiving, on the transaction object detail page, a limit of a deduction amount selected by the user according to the resource deduction information and a duration of a deduction period corresponding to the deduction amount; and

the generating the resource deduction request according to the selected resource deduction mode and sending the resource deduction request comprises:

generating the resource deduction request according to the selected limit of the deduction amount and the duration of the deduction period corresponding to the deduction amount, and sending the resource deduction request.

Clause 6. The method of any of clauses 1 to 4, wherein:

the resource deduction information comprises a first deduction item and different first parameter values of the first deduction item;

the first parameter value is a limit when the first deduction item is a deduction amount, or a duration when the first deduction item is a deduction period; and

the receiving, on the transaction object detail page, the resource deduction mode selected by the user according to the resource deduction information specifically comprises:

receiving, on the transaction object detail page, a first parameter value of the first deduction item selected by the user according to the resource deduction information;

before the generating the resource deduction request according to the selected resource deduction mode and sending the resource deduction request, the method further comprises:

sending the first parameter value of the first deduction item; and

receiving a second parameter value of a second deduction item corresponding to the first parameter value, wherein the second deduction item is either the deduction amount or the deduction period and is different from the first deduction item; and

the generating the resource deduction request according to the selected resource deduction mode and sending the resource deduction request comprises:

when the second parameter value of the second deduction item has been confirmed, generating the resource deduction request according to the selected first parameter value of the first deduction item and the confirmed second parameter value of the second deduction item, and sending the resource deduction request.

Clause 7. A transaction object providing method comprising:

pushing a transaction object detail page to a terminal, wherein the transaction object detail page comprises resource deduction information, and a resource deduction mode represented by the resource deduction information is used for replacing a payment mode of directly paying for a transaction object corresponding to the transaction object detail page;

receiving a transaction object acquisition request sent by the terminal; and

receiving first payment information of the transaction object from a second server after the transaction object is provided for the terminal.

Clause 8. A transaction object providing method comprising:

sending resource deduction information, wherein the resource deduction information is displayed on a transaction object detail page, and a resource deduction mode represented by the resource deduction information is used for replacing a payment mode of directly paying for a transaction object corresponding to the transaction object detail page;

receiving a resource deduction request, wherein the resource deduction request is generated by a terminal based on a resource deduction mode that a user selects according to the resource deduction information;

abating a deduction resource, and using the abated deduction resource as first payment information of the transaction object to pay for the transaction object; and

carrying out deduction processing on a remaining deduction resource after the abatement according to the resource deduction mode.

Clause 9. The method of clause 8, wherein before the sending the resource deduction information, the method further comprises:

obtaining price information corresponding to the transaction object when the terminal receives the transaction object detail page; and

determining multiple different resource deduction modes according to the price information, wherein each resource deduction mode is represented by a respective limit of a deduction amount and a respective duration of a deduction period corresponding to the limit of the deduction amount; and

the sending the resource deduction information comprises:

sending the resource deduction information to the terminal; or

sending the resource deduction information to a first server, to instruct the first server to send the resource deduction information to the terminal, wherein the resource deduction information comprises the multiple different resource deduction modes.

Clause 10. The method of clause 9, wherein the determining the multiple different resource deduction modes according to the price information comprises:

determining different limits of a preset number of deduction amounts; and for each limit, determining a quotient of the price information divided by a first product as a duration of a deduction period corresponding to the limit, wherein the first product is a product of a current real-time dynamic income multiplied by a difference between the limit value and the price information; or

determining different durations of a preset number of deduction periods; and for each duration, determining a sum between the price information and a quotient of the price information divided by a second product as a limit of a deduction amount corresponding to the duration, wherein the second product is a product of a current real-time dynamic income multiplied by the duration.

Clause 11. The method of clause 8, wherein:

before the sending the resource deduction information, the method further comprises:

obtaining price information corresponding to the transaction object when the terminal receives the transaction object detail page;

the sending the resource deduction information comprises:

sending a first deduction item and different first parameter values of the first deduction item to the terminal, wherein the first parameter value is a limit when the first deduction item is a deduction amount, and the first parameter value is a duration when the first deduction item is a deduction period;

before the receiving the resource deduction request, the method further comprises:

receiving a first parameter value of the first deduction item sent by the terminal;

determining a second parameter value of a second deduction item corresponding to the first parameter value according to the price information; and

sending the second parameter value of the second deduction item to the terminal, wherein the second deduction item is an item that is different from the first item in either the deduction amount or the deduction period; and

the receiving the resource deduction request comprises:

when the terminal has confirmed the received second parameter value, receiving a resource deduction request that is generated according to the first parameter value of the first deduction item and the second parameter value of the second deduction item and sent by the terminal.

Clause 12. The method of clause 8, wherein:

before the sending the resource deduction information, the method further comprises:

obtaining price information corresponding to the transaction object when the terminal receives the transaction object detail page;

the sending the resource deduction information comprises:

sending a first deduction item and different first parameter values of the first deduction item to a first server, to instruct the first server to send the first deduction item and the different first parameter values of the first deduction item to the terminal, wherein the first parameter value is a limit when the first deduction item is a deduction amount, and the first parameter value is a duration when the first deduction item is a deduction period;

before the receiving the resource deduction request, the method further comprises:

receiving a first parameter value of the first deduction item selected by the terminal and forwarded by the first server;

determining a second parameter value of a second deduction item corresponding to the first parameter value according to the price information; and

sending the second parameter value of the second deduction item to the first server, to instruct the first server to send the second parameter value of the second deduction item to the terminal, wherein the second deduction item is either the deduction amount or the deduction period and is different from the first deduction item; and

the receiving the resource deduction request comprises:

when the terminal has confirmed the received second parameter value, receiving a resource deduction request that is generated by the terminal according to the first parameter value of the first deduction item and the second parameter value of the second deduction item and forwarded by the first server.

Clause 13. The method of clause 11 or 12, wherein the determining the second parameter value of the second deduction item corresponding to the first parameter value according to the price information comprises:

when the first deduction item is the deduction amount, the second deduction item is the deduction period, and a duration of the deduction period is a quotient of the price information divided by a first product, wherein the first product is a product of a current real-time dynamic income multiplied by a difference between a limit of the deduction amount and the price information; or

when the first deduction item is the deduction period, the second deduction item is the deduction amount, and a limit of the deduction amount is a sum between the price information and a quotient of the price information divided by a second product, wherein the second product is a product of a current real-time dynamic income multiplied by a duration of the deduction period.

Clause 14. The method of any of clauses 8 to 13, wherein:

before the abating the deduction resource, the method further comprises:

receiving second payment information corresponding to the limit of the deduction amount corresponding to the resource deduction mode, the second payment information being sent by a preset payment account under the control of the terminal; and

determining a start time point of timing, and starting timing; and

the abating the deduction resource, and using the abated deduction resource as the first payment information of the transaction object to pay for the transaction object comprises:

determining whether the first server receives feedback information within a preset period of time starting from the start time point, the feedback information being sent by the terminal after acquiring the transaction object;
if the first server receives the feedback information within the preset period of time, abating the first payment information corresponding to the transaction object from the second payment information, and sending the first payment information to the first server; or
if the first server does not receive feedback information within a preset period of time, abating the first payment information corresponding to the transaction object from the second payment information when an end time point of the preset period of time arrives, and sending the first payment information to the first server.

Clause 15. The method of clause 14, wherein:

the carrying out deduction processing on the resource after the abatement according to the resource deduction mode comprises:

providing a value-added service for the remaining second payment information without the first payment information after the first payment information is sent to the first server and before the duration of the deduction period starting from the start time point and corresponding to the resource deduction mode comes to an end; and

when a duration starting from the start time point comes to an end, the method further comprises:

sending, to the preset account, third payment information corresponding to the limit of the deduction amount corresponding to the resource deduction mode, wherein the duration is the duration of the deduction period corresponding to the resource deduction mode.

Clause 16. A terminal, comprising:

a receiving module configured to receive a transaction object detail page pushed by a network server, wherein the transaction object detail page comprises resource deduction information, and a resource deduction mode represented by the resource deduction information is used for replacing a payment mode of directly paying for a transaction object corresponding to the transaction object detail page; and receive, on the transaction object detail page, a resource deduction mode selected by a user according to the resource deduction information; and

a sending module configured to generate a resource deduction request according to the selected resource deduction mode and send the resource deduction request, so that the network server carries out resource deduction according to the resource deduction request.

Clause 17. The terminal of clause 16, wherein the sending module is further configured to generate the resource deduction request according to the selected resource deduction mode and send the resource deduction request to a first server at a network, to instruct the first server to inform a second server to carry out resource deduction according to the resource deduction request; or

generate a resource deduction request according to the selected resource deduction mode and send the resource deduction request to a second server at the network, so that the second server carries out resource deduction according to the resource deduction request.

Clause 18. The terminal of clause 16, wherein the receiving module is further configured to receive the transaction object detail page pushed by a first server at a network; and

the first server sends price information of the transaction object to a second server when the terminal receives the transaction object detail page, so that the second server determines the resource deduction information according to the price information and a current real-time dynamic income, and feeds back the determined resource deduction information to the first server; and the first server sends the resource deduction information to the transaction object detail page for displaying.

Clause 19. The terminal of clause 16, wherein the sending module is further configured to trigger a payment information invoking module to send price information of the transaction object to a second server after the receiving module receives the transaction object detail page pushed by the network server, so that the second server determines the resource deduction information according to the price information and a current real-time dynamic income, and feeds back the determined resource deduction information to the transaction object detail page for displaying, wherein the payment information invoking module is set on the transaction object detail page.

Clause 20. The terminal of any of clauses 16 to 19, wherein:

the receiving module is further configured to receive, on the transaction object detail page, a limit of a deduction amount selected by the user according to the resource deduction information and a duration of a deduction period corresponding to the deduction amount; the resource deduction information comprises multiple different resource deduction modes, and each resource deduction mode is represented by a limit of a deduction amount and a duration of a deduction period corresponding to the limit of the deduction amount; and

the sending module is further configured to generate the resource deduction request according to the selected limit of the deduction amount and the duration of the deduction period corresponding to the deduction amount, and send the resource deduction request.

Clause 21. The terminal of any of clauses 16 to 19, wherein:

the receiving module is further configured to receive, on the transaction object detail page, a first parameter value of a first deduction item selected by the user according to the resource deduction information, the resource deduction information comprising the first deduction item and different first parameter values of the first deduction item, wherein the first parameter value is a limit when the first deduction item is a deduction amount, and the first parameter value is a duration when the first deduction item is a deduction period;

the sending module is further configured to send the first parameter value of the first deduction item before generating the resource deduction request according to the selected resource deduction mode and sending the resource deduction request;

the receiving module is further configured to receive a second parameter value of a second deduction item corresponding to the first parameter value, wherein the second deduction item is either the deduction amount or the deduction period and is different from the first deduction item; and

the sending module is further configured to, when the second parameter value of the second deduction item has been confirmed, generate the resource deduction request according to the selected first parameter value of the first deduction item and the confirmed second parameter value of the second deduction item, and send the resource deduction request.

Clause 22. A server, serving as a first server, comprising:

a pushing module configured to push a transaction object detail page to a terminal, wherein the transaction object detail page comprises resource deduction information, and a resource deduction mode represented by the resource deduction information is used for replacing a payment mode of directly paying for a transaction object corresponding to the transaction object detail page; and

a receiving module configured to receive a transaction object acquisition request sent by the terminal; and receive first payment information of the transaction object from a second server after the transaction object is provided for the terminal.

Clause 23. A server, serving as a second server, comprising:

a sending module configured to send resource deduction information, wherein the resource deduction information is displayed on a transaction object detail page, and a resource deduction mode represented by the resource deduction information is used for replacing a payment mode of directly paying for a transaction object corresponding to the transaction object detail page;

a receiving module configured to receive a resource deduction request, wherein the resource deduction request is generated by a terminal based on a resource deduction mode that a user selects according to the resource deduction information; and

a deduction resource processing module configured to abate a deduction resource, and use the abated deduction resource as first payment information of the transaction object to pay for the transaction object; and carry out deduction processing on the remaining deduction resource after the abatement according to the resource deduction mode.

Clause 24. The server of clause 23, further comprising:

a price acquisition module,

wherein:

the price acquisition module is configured to, before the sending module sends the resource deduction information, obtain price information corresponding to the transaction object when the terminal receives the transaction object detail page;

the deduction resource processing module is further configured to determine multiple different resource deduction modes according to the price information, wherein each resource deduction mode is represented by a limit of a deduction amount and a duration of a deduction period corresponding to the limit of the deduction amount; and

the sending module is further configured to send the resource deduction information to the terminal; or send the resource deduction information to a first server, to instruct the first server to send the resource deduction information to the terminal, wherein the resource deduction information comprises the multiple different resource deduction modes.

Clause 25. The server of clause 24, wherein:

the deduction resource processing module is configured to:

determine different limits of a preset number of deduction amounts; and for each limit, determine a quotient of the price information divided by a first product as a duration of a deduction period corresponding to the limit, wherein the first product is a product of a current real-time dynamic income multiplied by a difference between the limit value and the price information; or

determine different durations of a preset number of deduction periods; and for each duration, determine a sum between the price information and a quotient of the price information divided by a second product as a limit of a deduction amount corresponding to the duration, wherein the second product is a product of a current real-time dynamic income multiplied by the duration.

Clause 26. The server of clause 23, further comprising:

a price acquisition module,

wherein:

the price acquisition module is configured to, before the sending module sends the resource deduction information, obtain price information corresponding to the transaction object when the terminal receives the transaction object detail page;

the sending module is further configured to send a first deduction item and different first parameter values of the first deduction item to the terminal, wherein the first parameter value is a limit when the first deduction item is a deduction amount, and the first parameter value is a duration when the first deduction item is a deduction period;

the receiving module is further configured to, before receiving the resource deduction request, receive a first parameter value of the first deduction item sent by the terminal;

the deduction resource processing module is further configured to determine a second parameter value of a second deduction item corresponding to the first parameter value according to the price information;

the sending module is further configured to send the second parameter value of the second deduction item to the terminal, wherein the second deduction item is either the deduction amount or the deduction period and is different from the first deduction item; and

the receiving module is further configured to, when the terminal has confirmed the received second parameter value, receive a resource deduction request that is generated according to the first parameter value of the first deduction item and the second parameter value of the second deduction item and sent by the terminal.

Clause 27. The server of clause 23, further comprising:

a price acquisition module,

wherein:

the price acquisition module is configured to, before the sending module sends the resource deduction information, obtain price information corresponding to the transaction object when the terminal receives the transaction object detail page;

the sending module is further configured to send a first deduction item and different first parameter values of the first deduction item to a first server, to instruct the first server to send the first deduction item and the different first parameter values of the first deduction item to the terminal, wherein the first parameter value is a limit when the first deduction item is a deduction amount, and the first parameter value is a duration when the first deduction item is a deduction period;

the receiving module is further configured to: before receiving the resource deduction request, receive a first parameter value of the first deduction item selected by the terminal and forwarded by the first server;

the deduction resource processing module is further configured to determine a second parameter value of a second deduction item corresponding to the first parameter value according to the price information;

the sending module is further configured to send the second parameter value of the second deduction item to the first server, to instruct the first server to send the second parameter value of the second deduction item to the terminal, wherein the second deduction item is either the deduction amount or the deduction period and is different from the first deduction item; and

the receiving module is specifically configured to: when the terminal has confirmed the received second parameter value, receive a resource deduction request that is generated by the terminal according to the first parameter value of the first deduction item and the second parameter value of the second deduction item and forwarded by the first server.

Clause 28. The server of clause 26 or 27, wherein the deduction resource processing module is further configured to:

when the first deduction item is the deduction amount, the second deduction item is the deduction period, and a duration of the deduction period is a quotient of the price information divided by a first product, wherein the first product is a product of a current real-time dynamic income multiplied by a difference between a limit of the deduction amount and the price information; or

when the first deduction item is the deduction period, the second deduction item is the deduction amount, and a limit of the deduction amount is a sum between the price information and a quotient of the price information divided by a second product, wherein the second product is a product of a current real-time dynamic income multiplied by a duration of the deduction period.

Clause 29. The server of any of clauses 23 to 28, further comprising:

a timing module,

wherein

the receiving module is configured to: before the deduction resource processing module abates the deduction resource, receive second payment information corresponding to the limit of the deduction amount corresponding to the resource deduction mode, the second payment information being sent by a preset payment account under the control of the terminal; and

the timing module is configured to determine a start time point of timing, and start timing; and

the deduction resource processing module is further configured to: determine whether the first server receives feedback information within a preset period of time starting from the start time point, the feedback information being sent by the terminal after acquiring the transaction object; if the first server receives the feedback information within the preset period of time, abate the first payment information corresponding to the transaction object from the second payment information, and send the first payment information to the first server; and if the first server does not receive the feedback information within the preset period of time, abate the first payment information corresponding to the transaction object from the second payment information when an end time point of the preset period of time arrives, and send the first payment information to the first server.

Clause 30. The server of clause 29, wherein:

the deduction resource processing module is further configured to provide a value-added service for the remaining second payment information without the first payment information after the first payment information is sent to the first server and before the duration of the deduction period starting from the start time point and corresponding to the resource deduction mode comes to an end; and

the deduction resource processing module is further configured to send, to the preset account, third payment information corresponding to the limit of the deduction amount corresponding to the resource deduction mode when a duration starting from the start time point comes to an end, wherein the duration is the duration of the deduction period corresponding to the resource deduction mode.

What is claimed is:

1. A method comprising:
receiving a transaction object detail page pushed by a server, the transaction object detail page including resource deduction information, and a resource deduction mode represented by the resource deduction information being used for replacing a payment mode of directly paying for a transaction object corresponding to the transaction object detail page;
receiving, on the transaction object detail page, a resource deduction mode according to the resource deduction information; and
generating a resource deduction request according to the resource deduction mode and sending the resource deduction request.

2. The method of claim 1, wherein the generating the resource deduction request according to the resource deduction mode and sending the resource deduction request comprises:
generating the resource deduction request according to the selected resource deduction mode and sending the resource deduction request to a first server at a network, to instruct the first server to inform a second server to carry out resource deduction according to the resource deduction request; or
generating the resource deduction request according to the selected resource deduction mode and sending the resource deduction request to a second server at the network, so that the second server carries out resource deduction according to the resource deduction request.

3. The method of claim 1, wherein the receiving the transaction object detail page pushed by the server comprises:
receiving the transaction object detail page pushed by a first server at a network,
wherein:
the first server sends price information of the transaction object to a second server when a terminal receives the transaction object detail page, so that the second server determines the resource deduction information according to the price information and a current real-time dynamic income, and feeds back the determined resource deduction information to the first server, and the first server sends the resource deduction information to the transaction object detail page for displaying.

4. The method of claim 1, wherein, after the receiving the transaction object detail page pushed by the network server, the method further comprises:
sending price information of the transaction object to a second server, so that the second server determines the resource deduction information according to the price information and a current real-time dynamic income, and feeds back the determined resource deduction information to the transaction object detail page for displaying.

5. The method of claim 1, wherein:
the resource deduction information comprises multiple different resource deduction modes, and each resource deduction mode is represented by a respective limit of a deduction amount and a respective duration of a deduction period corresponding to the limit of the deduction amount.

6. The method of claim 5, wherein the receiving, on the transaction object detail page, the resource deduction mode according to the resource deduction information specifically comprises:
receiving, on the transaction object detail page, a limit of a deduction amount selected by the user according to the resource deduction information and a duration of a deduction period corresponding to the deduction amount.

7. The method of claim 5, wherein the generating the resource deduction request according to the selected resource deduction mode and sending the resource deduction request comprises:
generating the resource deduction request according to the selected limit of the deduction amount and the duration of the deduction period corresponding to the deduction amount, and sending the resource deduction request.

8. The method of claim 1, wherein:
the resource deduction information comprises a first deduction item and different first parameter values of the first deduction item; and
the first parameter value is a limit when the first deduction item is a deduction amount, or a duration when the first deduction item is a deduction period.

9. The method of claim 8, wherein the receiving, on the transaction object detail page, the resource deduction mode selected by the user according to the resource deduction information comprises:
receiving, on the transaction object detail page, a first parameter value of the first deduction item selected by the user according to the resource deduction information.

10. The method of claim 8, wherein, before the generating the resource deduction request according to the selected resource deduction mode and sending the resource deduction request, the method further comprises:
sending the first parameter value of the first deduction item; and
receiving a second parameter value of a second deduction item corresponding to the first parameter value, wherein the second deduction item is either the deduction amount or the deduction period and is different from the first deduction item.

11. The method of claim 10, wherein the generating the resource deduction request according to the resource deduction mode and sending the resource deduction request comprises:
when the second parameter value of the second deduction item has been confirmed, generating the resource deduction request according to the selected first parameter value of the first deduction item and the confirmed second parameter value of the second deduction item, and sending the resource deduction request.

12. A method comprising:
sending resource deduction information, the resource deduction information being displayed on a transaction object detail page, and a resource deduction mode represented by the resource deduction information being used for replacing a payment mode of directly paying for a transaction object corresponding to the transaction object detail page;
receiving a resource deduction request, the resource deduction request being generated by a terminal based on a resource deduction mode according to the resource deduction information;
abating a deduction resource and using the abated deduction resource as first payment information of the transaction object to pay for the transaction object; and
carrying out deduction processing on the deduction resource after the abatement according to the resource deduction mode.

13. The method of claim 12, wherein, before the sending the resource deduction information, the method further comprises:
obtaining price information corresponding to the transaction object when the terminal receives the transaction object detail page; and
determining multiple different resource deduction modes according to the price information, wherein each resource deduction mode is represented by a respective limit of a deduction amount and a respective duration of a deduction period corresponding to the limit of the deduction amount.

14. The method of claim 13, wherein the sending the resource deduction information comprises:
sending the resource deduction information to the terminal; or
sending the resource deduction information to a first server, to instruct the first server to send the resource deduction information to the terminal, wherein the resource deduction information comprises the multiple different resource deduction modes.

15. The method of claim 14, wherein the determining the multiple different resource deduction modes according to the price information comprises:
determining different limits of a preset number of deduction amounts; and for each limit, determining a quotient of the price information divided by a first product as a duration of a deduction period corresponding to the limit, wherein the first product is a product of a current real-time dynamic income multiplied by a difference between the limit value and the price information; or
determining different durations of a preset number of deduction periods; and for each duration, determining a sum between the price information and a quotient of the price information divided by a second product as a limit of a deduction amount corresponding to the duration, wherein the second product is a product of a current real-time dynamic income multiplied by the duration.

16. The method of claim 12, wherein, before the sending the resource deduction information, the method further comprises:
obtaining price information corresponding to the transaction object when the terminal receives the transaction object detail page.

17. The method of claim 16, wherein the sending the resource deduction information comprises:
sending a first deduction item and different first parameter values of the first deduction item to the terminal, wherein the first parameter value is a limit when the first deduction item is a deduction amount, and the first parameter value is a duration when the first deduction item is a deduction period.

18. The method of claim 17, wherein, before the receiving the resource deduction request, the method further comprises:
receiving a first parameter value of the first deduction item sent by the terminal;
determining a second parameter value of a second deduction item corresponding to the first parameter value according to the price information; and
sending the second parameter value of the second deduction item to the terminal, wherein the second deduction item is an item that is different from the first item in either the deduction amount or the deduction period.

19. The method of claim 18, wherein the receiving the resource deduction request comprises:
when the terminal has confirmed the received second parameter value, receiving a resource deduction request that is generated according to the first parameter value of the first deduction item and the second parameter value of the second deduction item and sent by the terminal.

20. A method comprising:
pushing a transaction object detail page to a terminal, wherein the transaction object detail page comprises resource deduction information, and a resource deduction mode represented by the resource deduction information is used for replacing a payment mode of directly paying for a transaction object corresponding to the transaction object detail page;
receiving a transaction object acquisition request sent by the terminal; and
receiving first payment information of the transaction object from a second server after the transaction object is provided for the terminal.
